(19) United States
(12) Patent Application Publication
(10) Pub. No.: US 2001/0033895 A1
(43) Pub. Date: Oct. 25, 2001

(54) Film forming method and film forming apparatus

(75) Inventors: Tomohide Minami, Kumamoto (JP); Takahiro Kitano, Kumamoto (JP); Yuji Matsuyama, Kumamoto (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Tokyo Electron Limited, Minato-ku (JP)

(21) Appl. No.: 09/840,179

(22) Filed: Apr. 24, 2001

(30) Foreign Application Priority Data
Apr. 25, 2000 (JP) 2000-123834

(51) Int. Cl. B05D 3/12; B05C 11/02

(52) U.S. Cl. 427/240; 118/52

(57) ABSTRACT

The present invention is a film forming method for forming a film of a coating solution on a substrate, comprising the steps of spreading the coating solution supplied to a center of the substrate by rotating the substrate, and supplying solvent vapor of the coating solution to the coating solution spread over the substrate while rotating the substrate to thin the film of the coating solution formed on the substrate. Accordingly, it becomes possible that the film of the coating solution which is formed by spreading the coating solution over the substrate is maintained at a low viscosity, and that the film can be further thinned. The necessary quantity of the coating solution can be also reduced. Moreover, since solvent vapor is supplied onto the coating film, by controlling the supply quantity or the supply position of the solvent vapor, the uniformity of the coating solution film can be obtained, and the thickness of the coating solution film can be controlled.

### BACKGROUND OF THE INVENTION

1. Field of the Invention

The present invention relates to a film forming method and a film forming apparatus for a substrate.

2. Description of the Related Art

In photolithography of the process of fabricating a semiconductor device, for example, a resist coating treatment of coating, for example, the surface of a semiconductor wafer (hereinafter referred to as “a wafer”) which is a substrate with a resist solution and forming a resist film thereon, exposure processing of exposing the wafer in accordance with a pattern, and a developing treatment of developing the exposed wafer are performed, and thus a predetermined circuit pattern is formed on the wafer.

In the aforesaid resist coating treatment, the wafer is usually mounted on a rotatable spin chuck and rotated by the rotation of the spin chuck. When a resist solution is supplied to the center of the wafer, the resist solution is spread by the rotation, and a film of the resist solution is formed on the wafer by a so-called spin-coating method.

In the aforesaid method, however, since a large quantity of resist solution is thrown out by the rotation of the wafer and thereby a large quantity of chemical is consumed. Hence, a reduction in the quantity of the chemical comes to be demanded. But, if the quantity of the chemical to be supplied onto the wafer W is reduced only, a solvent in the resist solution volatilizes while the resist solution spreads over the wafer, whereby the viscosity of the resist solution increases. As a result, the thickness of a resist film formed on the wafer sometimes becomes more ununiform toward the outer peripheral portion of the wafer.

Accordingly, Japanese Patent Bulletin 2-133916 proposes that a solvent of a resist solution is previously supplied to a peripheral portion of a wafer before the coating of the resist solution so that a resist film is formed uniformly also at the peripheral portion of the wafer while the quantity of chemical is reduced, whereby a rise in the viscosity of the resist solution at the outer peripheral portion of the wafer is suppressed and hence the resist solution is spread smooth.

In recent years, however, the request to form a thinner film on the wafer has been increasing, but the aforesaid film forming method can not fully comply with this request.

### SUMMARY OF THE INVENTION

The present invention is made in view of such aspects, and its object is to realize thinning of a film to be formed on a substrate such as a wafer while considering a reduction in the quantity of a chemical.

To attain this object, a film forming method of the present invention comprises the steps of: spreading a coating solution supplied to a center of a substrate by rotating the substrate; and supplying solvent vapor of the coating solution to the coating solution spread over the substrate while rotating the substrate to thin the film of the coating solution to be formed on the substrate.

According to another aspect of the present invention, a film forming method of the present invention comprises the steps of: spreading a coating solution supplied to a center of a substrate by rotating the substrate; supplying solvent vapor of the coating solution onto the substrate before the supply of the coating solution; thereafter supplying the coating solution to the substrate and spreading the supplied coating solution by rotating the substrate at a first rotation speed; thereafter rotating the substrate at a second rotation speed higher than the first rotation speed to spread the coating solution over an entire surface of the substrate; and thereafter rotating the substrate at a third rotation speed lower than the second rotation speed while supplying the solvent vapor of the coating solution to the entire surface of the substrate to thin the film of the coating solution spread over the substrate.

The first to third rotation speeds are fixed according to the type of coating solution, the type of solvent vapor, the thickness of the coating film to be formed finally, or the like. Further, the supply of the solvent vapor to the entire surface of the substrate is performed not only when the solvent vapor is supplied at a time to the entire surface of the substrate, but also when the solvent vapor is first supplied to a portion of the substrate and finally supplied to the entire surface of the substrate by moving a means for supplying the solvent vapor. Furthermore, the supply of the solvent vapor may be performed simultaneously with the start of the spreading step, or performed in the middle of the spreading step.

According to another aspect of the present invention, a film forming method of the present invention comprises: spreading the coating solution supplied to a center of the substrate by rotating the substrate; supplying solvent vapor of the coating solution onto the substrate before the supply of the coating solution; thereafter supplying the coating solution to the substrate and spreading the supplied coating solution by rotating the substrate at a first rotation speed; thereafter rotating the substrate at a second rotation speed higher than the first rotation speed to spread the coating solution over an entire surface of the substrate; and thereafter rotating the substrate at a third rotation speed lower than the second rotation speed while a solvent atmosphere with a predetermined concentration is maintained at least in the vicinity of the substrate to thin the film of the coating solution spread over the substrate. Incidentally, the vicinity of the substrate means an area where the solvent atmosphere touches at least the coating solution applied on the substrate.

According to still another aspect of the present invention, a film forming method of the present invention comprises: spreading the coating solution supplied to a center of the substrate by rotating the substrate; supplying a solvent of the coating solution onto an entire surface of the substrate before the supply of the coating solution; rotating the substrate at a predetermined rotation speed to vaporize the solvent supplied onto the substrate; thereafter supplying the solvent of the coating solution again to at least a peripheral portion of the substrate; spreading the coating solution supplied to the substrate by rotating the substrate at a first rotation speed; and thereafter rotating the substrate at a second rotation speed higher than the first rotation speed to spread the coating solution over the entire surface of the substrate. Incidentally, the vaporization of the solvent supplied onto the substrate does not mean that the solvent is vaporized completely from the substrate and the substrate is dried, but means that the solvent is vaporized to the extent that a thin film of the solvent is formed on the surface of the substrate. Further, the solvent includes a vaporized solvent in addition to a liquid solvent.

A film forming apparatus of the present invention is a film forming apparatus for spreading a coating solution supplied to a center of a substrate by rotating the substrate to form a film of the coating solution on the substrate, the apparatus comprising a solvent vapor discharge plate for supplying solvent vapor to an entire surface of the substrate.

Hitherto, if the thinning of the film of the coating solution spread over the entire surface of the substrate is tried by further rotating the substrate, the solvent and the like in the coating solution are vaporized by the rotation for a long time, and the viscosity of the coating solution rises, whereby the thinning of the film is not realized suitably in some cases. According to the present invention, however, the solvent vapor is supplied onto the substrate during the rotation of the substrate, whereby the viscosity of the coating solution is maintained, resulting in the suitable formation of a thinner film of the coating solution.

Furthermore, the solvent vapor is supplied onto the substrate before the supply of the coating solution, the coating solution is then supplied to the center of the substrate which is being rotated at a relatively low speed, and thereafter the coating solution already supplied is spread over the entire surface of the substrate by rotating the substrate at a higher speed. Thereby, even if the supply quantity of the coating solution is reduced, the viscosity of the coating solution is prevented from rising by the aforesaid supply of the solvent vapor before coating when the coating solution is spread.

The solvent atmosphere with the predetermined concentration is maintained in the vicinity of the substrate, which suppresses the volatilization of the solvent from the coating solution and a rise in the viscosity of the coating solution.

Moreover, by supplying the solvent onto the substrate before the supply of the coating solution and thereafter rotating the substrate to vaporize the solvent, wettability is improved over the entire surface of the substrate, and thus coating solution can be spread smoother, whereby the coating solution supplied thereafter can be spread smoother and evenly over the entire surface of the substrate. Accordingly, unlike prior arts, the coating solution is spread smooth not only on the peripheral portion of the substrate but also over the entire surface of the substrate, leading to the formation of a thinner film. Furthermore, after the coating solution is once vaporized, the solvent is supplied to the outer peripheral portion of the substrate as described above. Consequently, even if the scattering of the coating solution is held to the minimum by setting the rotation speed of the substrate on the occasion of supply of the coating solution at a relatively low speed, the coating solution can be spread smooth, resulting in a reduction in the quantity of the coating solution.

### BRIEF DESCRIPTION OF THE DRAWINGS

FIG. 1 is a plan view showing a schematic structure of a coating and developing system in which a resist coating unit used in the present embodiments is incorporated;

FIG. 2 is a front view of the coating and developing system in FIG. 1;

FIG. 3 is a rear view of the coating and developing system in FIG. 1;

FIG. 4 is an explanatory view of a vertical section of a resist coating unit used in a first embodiment;

FIG. 5 is an explanatory view of a horizontal section of the resist coating unit shown in FIG. 4;

FIG. 6 is an explanatory view showing a step of supplying solvent vapor to a peripheral portion of a wafer from a solvent vapor supply nozzle;

FIG. 7 is an explanatory view showing a step of supplying a resist solution to a center of the wafer from a discharge nozzle;

FIG. 8 is an explanatory view showing a step of spreading the resist solution supplied in FIG. 7 over the entire surface of the wafer;

FIG. 9 is an explanatory view showing a step of supplying the solvent vapor onto the resist solution spread over the entire surface of the wafer in FIG. 8;

FIG. 10 is an explanatory view of a vertical section of a resist coating unit used in a second embodiment;

FIG. 11 is an explanatory view of a vertical section of a resist coating unit used in a third embodiment;

FIG. 12 is an explanatory view of a horizontal section of the resist coating unit shown in FIG. 11;

FIG. 13 is an explanatory view showing a step of discharging a solvent to the wafer from a solvent discharge nozzle;

FIG. 14 is an explanatory view showing a step of vaporizing the solvent supplied in FIG. 13;

FIG. 15 is an explanatory view showing a step of discharging the solvent to the peripheral portion of the wafer from the solvent discharge nozzle;

FIG. 16 is an explanatory view showing a step of supplying the resist solution to the center of the wafer from a discharge nozzle;

FIG. 17 is an explanatory view showing a step of spreading the resist solution supplied onto the wafer in FIG. 16;

FIG. 18 is an explanatory view showing a step of discharging the solvent to the entire surface of the wafer from a solvent vapor discharge nozzle;

FIG. 19 is an explanatory view showing a state of use of a solvent vapor discharge plate; and

FIG. 20 is a bottom view of the solvent vapor discharge plate.

### DETAILED DESCRIPTION OF THE PREFERRED EMBODIMENT

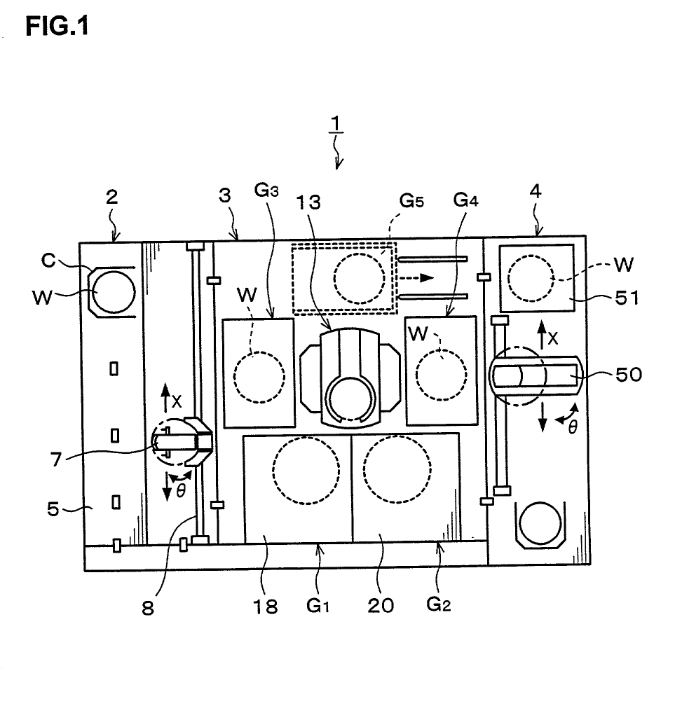

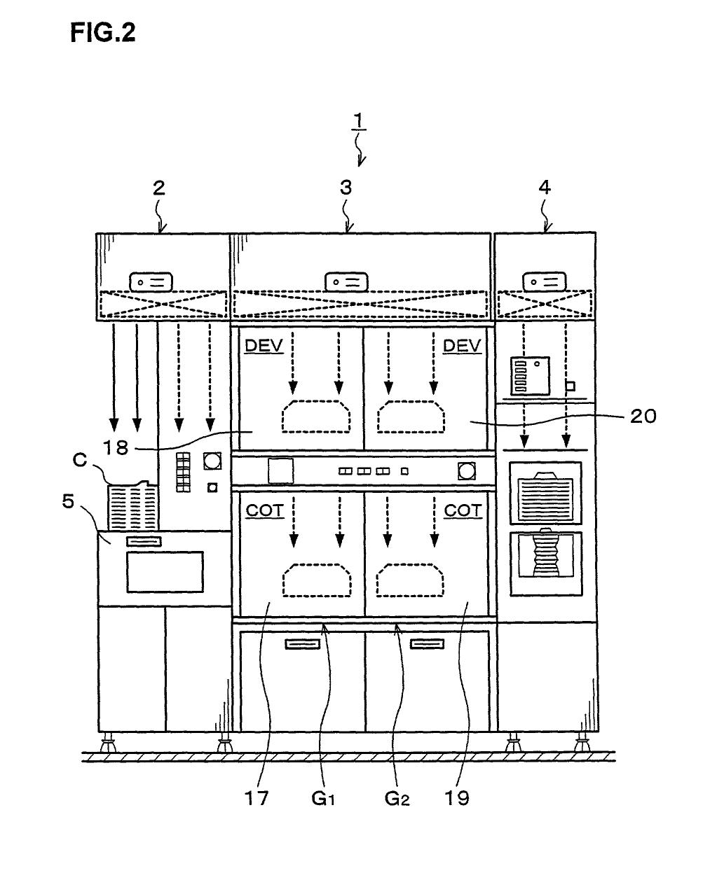

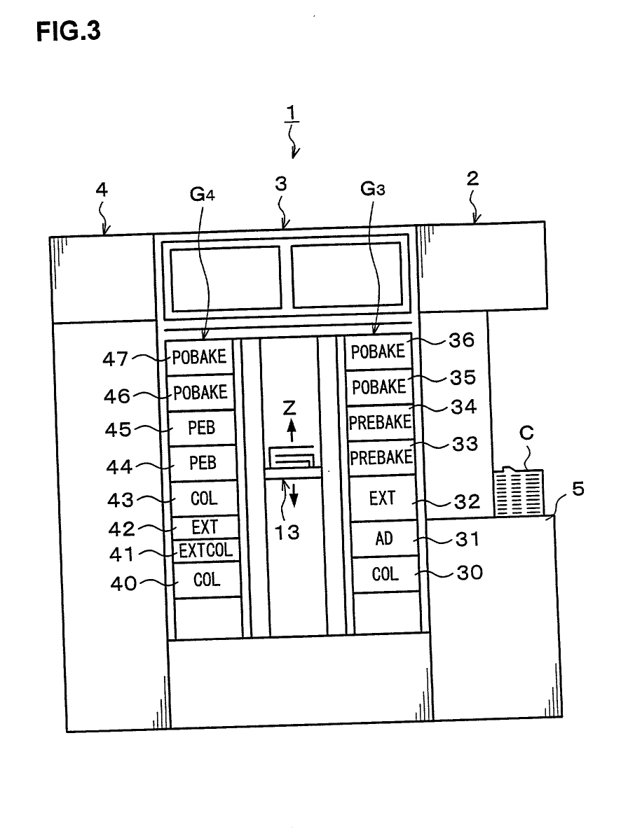

The present invention will be explained in detail below by explaining preferred embodiments of the present invention. In the present embodiments, a film forming method of the present invention is embodied by a resist coating method. FIG. 1 is a plan view of a coating and developing system 1 including a resist coating unit in which the resist coating method is carried out FIG. 2 is a front view of the coating and developing system 1, and FIG. 3 is a rear view of the coating and developing system 1.

As shown in FIG. 1, the coating and developing system 1 has a structure in which a cassette station 2 for transferring, for example, 25 wafers W per cassette C, as a unit, from/to the outside into/from the coating and developing system 1 and carrying the wafer W into/out of a cassette C, a processing station 3 where various kinds of processing units each of which performs a predetermined treatment for the wafers W one by one in a coating and developing process are stacked in multiple tiers, and an interface section 4 for receiving and sending the wafer W from/to an aligner 13 not illustrated but provided adjacent to the processing station 3 are integrally connected.

In the cassette station 2, a plurality of cassettes C are freely mounted in a line in an X-direction (in a top-to-bottom direction in FIG. 1) at predetermined positions on a cassette mounting table 5 which constitutes a mount. A wafer carrier 7 movable in the direction of arrangement of the cassettes (the X-direction) and in the direction of arrangement of the wafers W housed in the cassette C (a Z-direction, i.e., vertical direction) can freely move along a carrier path 8 and selectively get access to each of the cassettes C.

The wafer carrier 7 has an alignment function of aligning the wafer W. This wafer carrier 7 is structured to be able to get access to an extension unit 32 included in a third processing unit group G3 on the processing station 3 side as will be described later.

In the processing station 3, a main carrier unit 13 is disposed in the middle thereof, and around the main carrier unit 13, various processing units are stacked in multiple tiers to compose processing unit groups. In this coating and developing system 1, four processing unit groups G1, G2, G3, and G4 are disposed. The first and second processing unit groups G1 and G2 are disposed on the front side of the coating and developing system 1. The third processing unit group G3 is disposed adjacent to the cassette station 2. The fourth processing unit group G4 is disposed adjacent to the interface section 4. Moreover, a fifth processing unit group G5 shown by a broken line can be specially disposed on the rear side as an option. The main carrier unit 13 can carry the wafer W into/out of various processing units which are disposed in these processing unit groups G1 to G5 and will be described later.

In the first processing unit group G1, for example, as shown in FIG. 2, a resist coating unit 17 for forming a resist film by coating the wafer W with a resist solution and a developing unit 18 for treating the wafer W by supplying a developing solution to the wafer W are stacked in two tiers from the bottom in order. Similarly, in the second processing unit group G2, a resist coating unit 19 and a developing unit 20 are stacked in two tiers from the bottom in order.

In the third processing unit group G3, for example, as shown in FIG. 3, a cooling unit 30 for subjecting the wafer W to a cooling treatment, an adhesion unit 31 for enhancing adhesion of the resist solution and the wafer W, an extension unit 32 for making the wafer W wait, prebaking units 33 and 34 for drying a solvent in the resist solution, postbaking units 35 and 36 for performing a heat treatment after a developing treatment, or the like are stacked, for example, in seven tiers from the bottom in order.

In the fourth processing unit group G4, for example, a cooling unit 40, an extension and cooling unit 41 for naturally cooling the mounted wafer W, an extension unit 42, a cooling unit 43, post-exposure baking units 44 and 45 for performing a heat treatment after exposure processing, postbaking units 46 and 47, or the like are stacked, for example, in eight tiers from the bottom in order.

A wafer carrier 50 is provided in the middle of the interface section 4. The wafer carrier 50 is structured to be freely movable in the X-direction (the top-to-bottom direction in FIG. 1) and the Z-direction (the vertical direction) and rotatable in a θ-direction (the direction of rotation around a Z-axis) so as to be able to get access to the extension and cooling unit 41 and the extension unit 42 which are included in the fourth processing unit group G4, a peripheral aligner 51, and an aligner not illustrated.

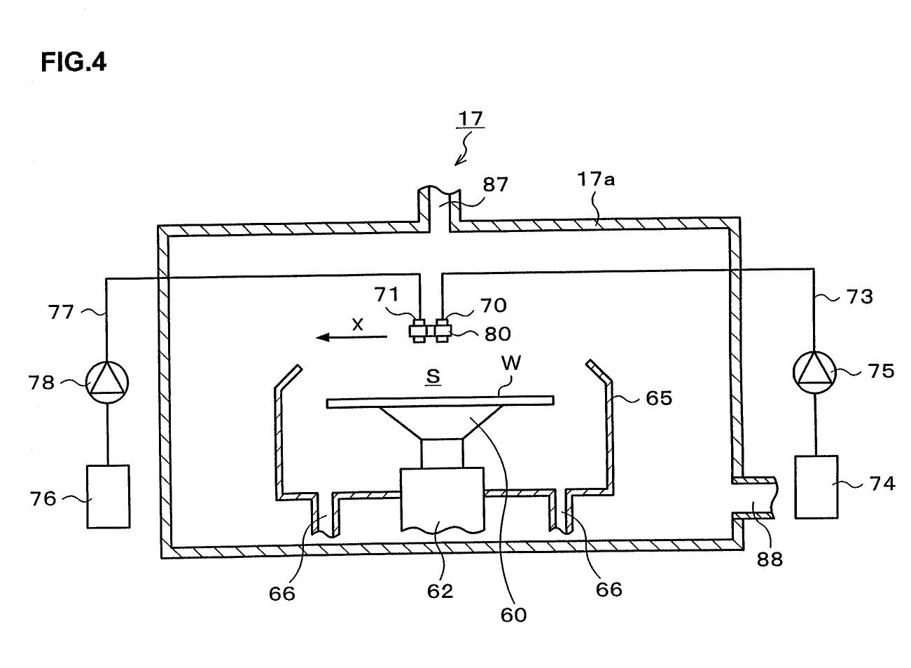

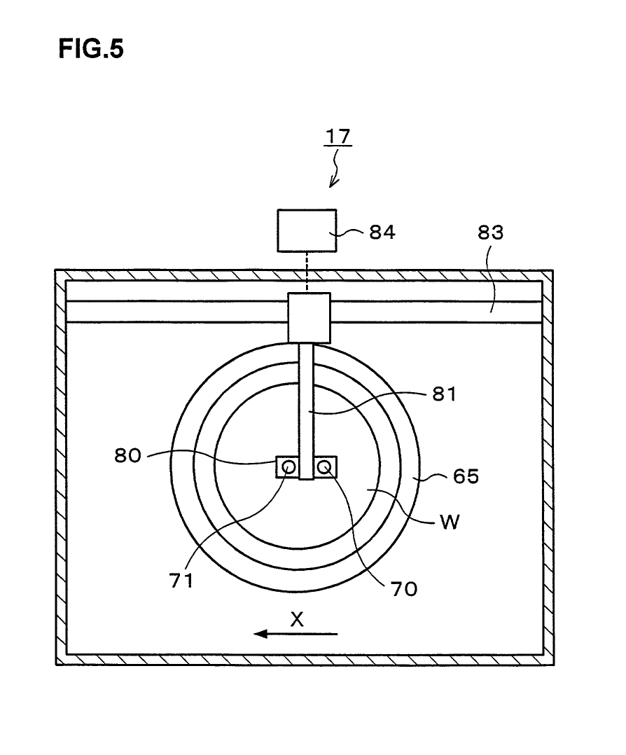

The structure of the aforesaid resist coating unit 17 will be explained. As shown in FIG. 4 and FIG. 5, provided in a casing 17a of this resist coating unit 17 is a spin chuck 60 the top face of which is flat and which has a suction port not illustrated in its center. The wafer W carried into the resist coating unit 17 is horizontally suction-held on the spin chuck 60. Under the spin chuck 60, a rotation drive mechanism 62 which rotates the spin chuck 60 and can change its rotation speed is provided, whereby the wafer W held by the spin chuck 60 can be rotated at a speed proper for each step.

Moreover, the rotation drive mechanism 62 of the spin chuck 60 has a function of freely moving the spin chuck 60 up and down, and when the wafer W is carried in and out, the rotation drive mechanism 62 moves the spin chuck 60 vertically to enable the delivery of the wafer W from/to the main wafer carrier 13.

An annular cup 65 with the top thereof open is provided to surround the outer periphery of the spin chuck 60 and catches a resist solution spilt from the wafer W, which is suction-held on the spin chuck 60 and rotated, by centrifugal force, thereby preventing the units thereabout from being contaminated. At the bottom of the cup 65, a drain pipe 66 for draining the resist solution spilt from the wafer W is provided.

Above the spin chuck 60, a discharge nozzle 70 for discharging the resist solution to the wafer W and a solvent vapor discharge nozzle 71 for discharging solvent vapor of the resist solution to the wafer W are movably provided. The discharge nozzle 70 communicates with a buffer tank 74 by a first pipeline 73, and a first pump 75 is provided in this first pipeline 73. Thereby, the resist solution in the buffer tank 74 is sent to the discharge nozzle 70 and discharged from the discharge nozzle 70 in predetermined timing and at predetermined pressure.

The solvent vapor discharge nozzle 71 communicates with a solvent tank 76 storing a solvent for the resist solution, for example, a thinner such as ethyl lactate by a second pipeline 77, and a second pump 78 is provided in this second pipeline 77. Thereby, solvent vapor vaporized in the solvent tank 76 can be sent to the solvent vapor discharge nozzle 71 and discharged from the solvent vapor discharge nozzle 71 in predetermined timing. Accordingly, it becomes possible to supply the resist solution and the solvent vapor onto the wafer W rotated by the aforesaid rotation drive mechanism 62, and to form a predetermined resist film on the wafer W by a so-called spin-coating method.

The discharge nozzle 70 and the solvent vapor discharge nozzle 71 are held, for example, by a nozzle holder 80, and this nozzle holder 80 is held by an arm 81 as shown in FIG. 5. The arm 81 is structured to be freely movable on a rail 83 which extends in one direction (the X-direction in FIG. 5) on the wafer W, and the timing, speed, and the like of its movement are controlled by a movement controller 84. Hence, the aforesaid discharge nozzle 70 and solvent vapor discharge nozzle 71 are structured to be freely movable on the wafer W with the movement of the arm 81.

A gas supply port 87 for supplying a predetermined gas, for example, clean air, to a treatment chamber S is provided in a top face of the casing 17a, and an exhaust port 88 for exhausting an atmosphere in the treatment chamber S is provided in a side face of the casing 17a, whereby a predetermined atmosphere is maintained in the treatment chamber S, and a regular stream is produced in the treatment chamber S so as to purge the interior of the treatment chamber S.

Next, a resist coating method carried out in the resist coating unit 17 structured as above will be explained with a process of photolithography performed in the coating and developing system 1.

First, one untreated wafer W is taken out of the cassette C by the wafer carrier 7 and carried into the adhesion unit 31 included in the third processing unit group G3, where, for example, HMDS which enhances the adhesion of the resist solution is applied on the surface of the wafer W. The wafer W is then transferred to the cooling unit 30 by the main carrier unit 13 and cooled to a predetermined temperature. Thereafter, the wafer W is transferred to the resist coating unit 17 or 19 where the resist film is formed.

The wafer W on which the resist film is formed in this resist coating unit 17 or 19 is transferred to the prebaking unit 33 or 34 and the cooling unit 40 in order by the main carrier unit 13. Thereafter, the wafer W is subjected to predetermined treatments such as exposure processing, a developing treatment, and the like in various processing units, and thus a series of coating and developing treatments are completed.

The process of the aforesaid resist coating method will be explained in detail. First, the wafer W which has undergone a pretreatment is carried into the resist coating unit 17 by the main carrier unit 13 and stopped at a predetermined position above the spin chuck 60. The main carrier unit 13 descends while holding the wafer W, and the wafer W is mounted on the top face of the spin chuck 60, which previously ascends and stands by, and suction-held. With the descent of the spin chuck 60, the wafer W is lowered and disposed at a predetermined position in the cup 65.

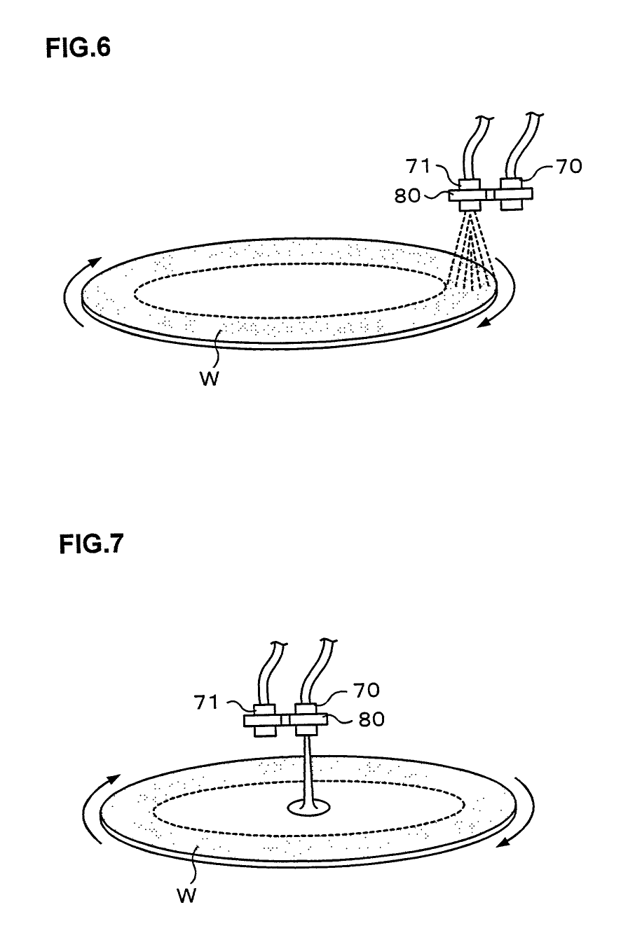

Subsequently, the solvent vapor discharge nozzle 71 which has been waiting outside the cup 65 is moved to a position above the peripheral portion of the wafer W, and at the same time the wafer W is rotated at a predetermined speed, for example, 100 rpm by the rotation drive mechanism 62. Then, as shown in FIG. 6, the solvent vapor is supplied to the peripheral portion of the wafer W from the solvent vapor discharge nozzle 71 for a predetermined period of time, for example, three seconds, thereby improving wettability of the peripheral portion of the wafer W.

In this case, the temperature of the solvent vapor may be lower than the temperature of the solvent which is usually contained in the resist solution and set at a normal temperature (for example, 23° C.). Thereby, the temperature of the solvent at the peripheral portion of the wafer W becomes low, whereby vaporization at the peripheral portion of the wafer W is suppressed when the wafer W is rotated, resulting in the realization of more desirable wettability. Moreover, the quantity of the solvent to be used can be reduced.

Thereafter, the supply of the solvent vapor is stopped, and the discharge nozzle 70 is moved to a position above the center of the wafer W. At this time, the rotation speed of the wafer W is decreased to a first rotation speed, for example, 80 rpm. Then, as shown in FIG. 7, the resist solution is discharged onto the wafer W from the discharge nozzle 70, for example, for one second.

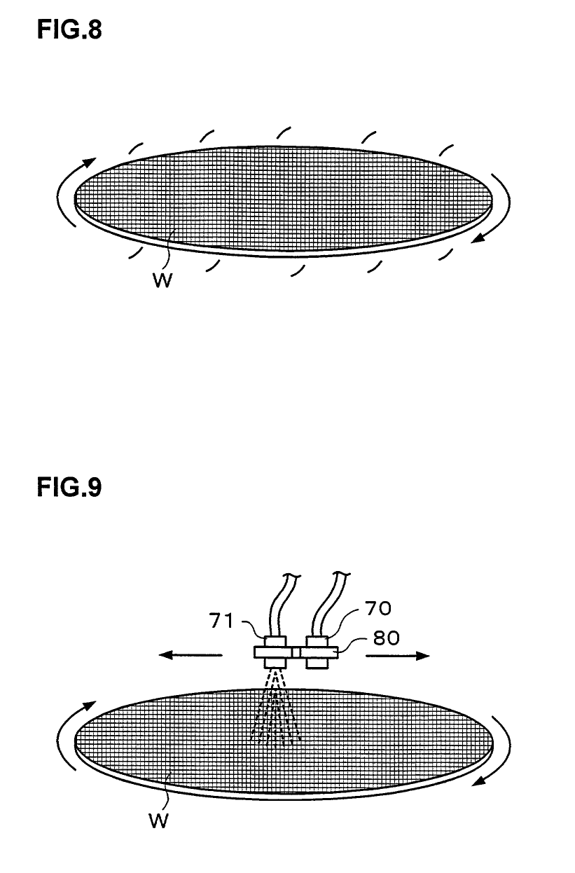

When the supply of the resist solution is then stopped, the rotation speed of the wafer W is increased to a second rotation speed, for example, 4500 rpm, and thereafter as shown in FIG. 8, the resist solution supplied to the center of the wafer W is spread over the entire surface of the wafer W while the rotation speed is maintained at 4500 rpm for two seconds.

Subsequently, as shown in FIG. 9, while moving right and left (in a positive direction and a negative direction of the X-direction in FIG. 4 and FIG. 5) above the wafer W, the solvent vapor discharge nozzle 71 jets the solvent vapor and supplies the solvent vapor onto the wafer W. On this occasion, the rotation speed of the wafer W is decreased to a third rotation speed, for example, 2500 rpm which is lower than the second rotation speed. When the wafer W is rotated for a predetermined period of time while the solvent vapor is supplied onto the wafer W, the resist solution which has been spread in the previous step is further spread and thrown out while maintaining a proper viscosity, and a film of the resist solution is thinned to a predetermined thickness. Incidentally, by controlling the total quantity of the solvent vapor to be supplied to respective portions on the wafer W in each of the portions at this time, the thickness of the resist film to be formed can be made uniform within the surface of the wafer W. As a method thereof, a method of controlling the third rotation speed, the moving speed of the solvent vapor supply nozzle 71, or the supply quantity and supply position of the solvent vapor can be proposed.

When the thickness of the film of the resist solution formed on the wafer W is thinned to the predetermined thickness, the supply of the solvent vapor is stopped, and the resist film formed on the wafer W is dried by rotating wafer W, for example, for 20 seconds.

Thereafter, the rotation of the wafer W is stopped, and the step of forming the resist film is completed. The wafer W is raised again by the spin chuck 60, delivered to the main carrier unit 13, and carried out of the resist coating unit 17.

In the aforesaid embodiment, since the solvent vapor is supplied to the peripheral portion of the wafer W before the supply of the resist solution, even if the resist solution is supplied onto the wafer W rotated at a low speed, the situation that the solvent in the resist solution volatilizes, the viscosity of the resist solution rises, and that the resist solution is not spread properly at the peripheral portion of the wafer W is suppressed. After the resist solution is once spread, the solvent vapor is supplied again onto the wafer W, and the wafer W is rotated at the third rotation speed, whereby the resist solution is maintained at a low viscosity, which makes it possible to make the film of the resist solution thinner.

In the aforesaid embodiment, after the resist solution is spread over the entire surface of the wafer W while the wafer W is rotated at the second rotation speed, the solvent vapor is supplied to make the resist film thinner, but the solvent vapor may be supplied also in the spreading step (FIG. 8). In this case, concurrently with the increase of the rotation speed of the wafer W to the second rotation speed, the solvent discharge nozzle 71 is moved above the wafer W as described above while jetting the solvent vapor. Hence the volatilization of the solvent in the resist solution is suppressed from the earlier stage, whereby the resist solution is spread smoother, resulting in the formation of the evener resist film.

Incidentally, the aforesaid step of thinning the film to be formed on the wafer W by rotating the wafer W while supplying the solvent vapor can be applied to a resist solution film forming method through other steps regardless of the previous steps. Further, the aforesaid step can be applied to the formation of a film other than the resist solution film, for example, a developing solution film in the developing treatment.

Moreover, although the solvent vapor is supplied so that the viscosity of the resist solution does not rise when the film of the resist solution is thinned in the aforesaid embodiment, a solvent atmosphere with a predetermined concentration may be maintained in the vicinity of the wafer W so that the solvent in the resist solution is not volatilized. This case will be explained below as a second embodiment.

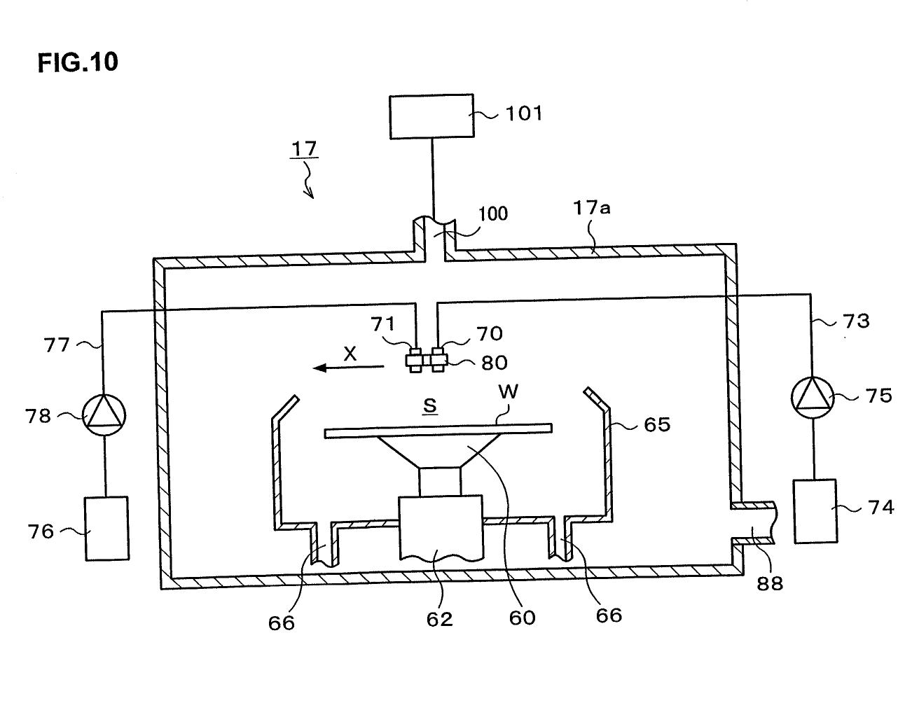

In the resist coating unit 17 used in the second embodiment, as shown in FIG. 10, a gas supply unit 101 for supplying a gas containing the solvent of the resist solution, for example, nitrogen gas which is an inert gas into the treatment chamber S is provided to communicate with a gas supply port 100, and the nitrogen gas containing the solvent is supplied from the gas supply port 100 so that a solvent atmosphere with a predetermined concentration can be maintained in the treatment chamber S. In the same way as in the first embodiment, the resist solution is spread over the entire surface of the wafer W, and when the film of the resist solution is thinned, the nitrogen gas containing the solvent vapor is supplied into the treatment chamber S from the gas supply unit 101, whereby the solvent atmosphere with the predetermined concentration is maintained in the vicinity of the wafer W. Thus, the volatilization of the solvent existing in the resist film on the wafer W is suppressed, and the viscosity of the resist solution is maintained, leading to suitable thinning of the resist film. Incidentally, as the gas containing the solvent of the resist solution, clean air may be used in place of nitrogen gas.

The aforesaid supply of nitrogen gas may be performed not only when the resist film is thinned, but also when the resist solution applied on the wafer W is spread. As a result, likewise with the aforesaid direct supply of the solvent vapor, the volatilization of the solvent in the resist solution is suppressed from the earlier stage, whereby the resist solution is spread smoother, resulting in the formation of the evener resist film.

Next, a case where a liquid solvent is supplied to the entire surface of the wafer W before the resist solution is supplied to the wafer W will be explained as a third embodiment.

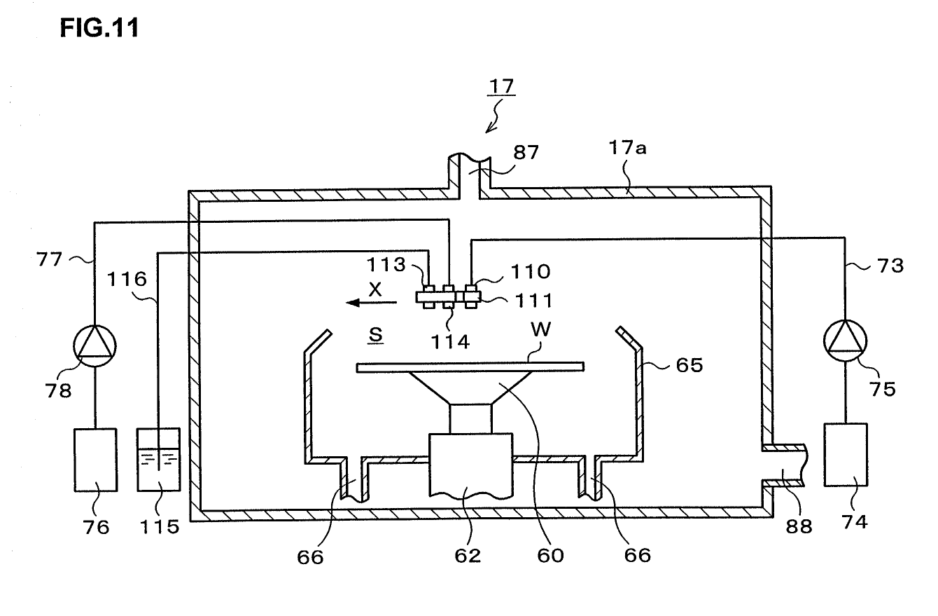

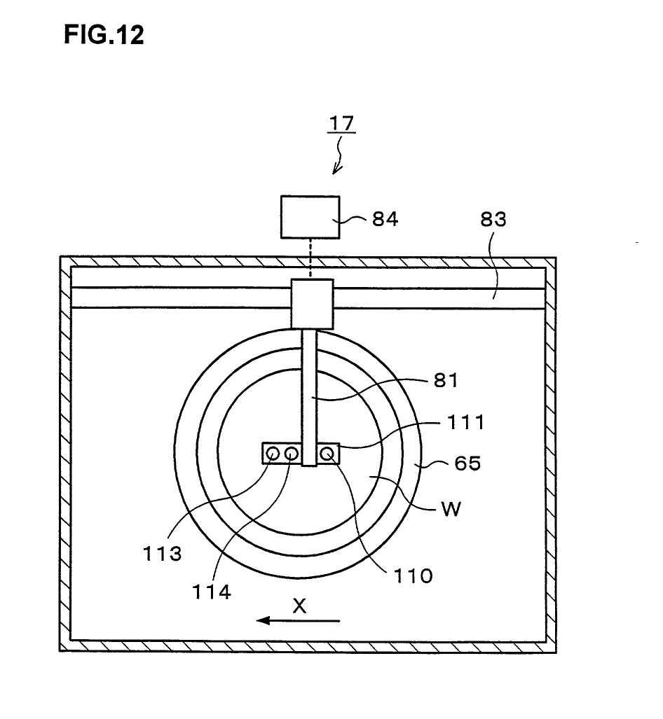

As shown in FIG. 11 and FIG. 12, provided in the resist coating unit 17 used in carrying out the third embodiment is a solvent discharge nozzle 113 for discharging a liquid solvent of the resist solution which is held together with a discharge nozzle 110 for discharging the resist solution and a solvent vapor discharge nozzle 114 for discharging the solvent vapor by the same nozzle holder 111. This solvent discharge nozzle 113 communicates with a solvent tank 115 storing the solvent by a third pipeline 116 and is structured to be able to discharge the solvent from the solvent tank 115 onto the wafer W. A mechanism for allowing the movement of the discharge nozzle 110, the solvent vapor discharge nozzle, and the solvent discharge nozzle 113 is the same as in the first embodiment, and they are moved by the movement of the arm 81 on the rail 83 as shown in FIG. 12. Respective supply mechanisms of the resist solution and the solvent vapor of the discharge nozzle 110 and the solvent vapor discharge nozzle 114 are also structured in the same manner as in the first embodiment.

Next, a film forming method according to the third embodiment will be explained. As with the first embodiment, the wafer W is first carried into the resist coating unit 17 and mounted on the spin chuck 60.

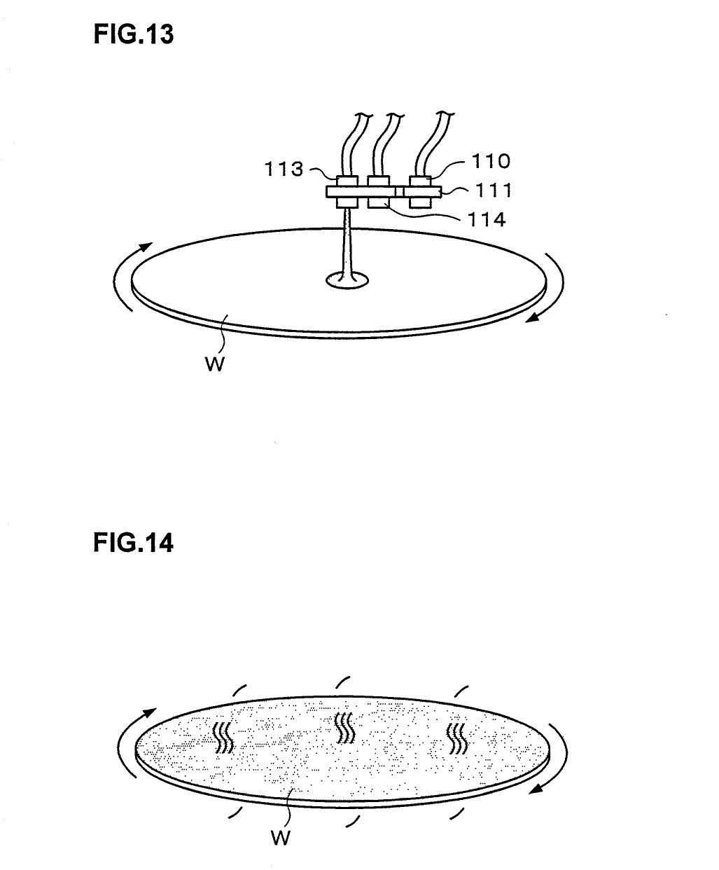

Subsequently, the solvent discharge nozzle 113 is moved to be located above the center of the wafer W, and the wafer W is rotated, for example, at 1000 rpm by the spin chuck 60. As shown in FIG. 13, the liquid solvent is then discharged onto the wafer W from the solvent discharge nozzle 113 and supplied to the entire surface of the wafer W.

After the solvent is discharged, for example, for three seconds, the discharge is stopped. Thereafter, as shown in FIG. 14, by continuing the rotation of the wafer W, the excessive solvent is vaporized so that the solvent supplied onto the wafer W reaches a proper quantity. Thereby, a thin solvent film is formed over the entire surface of the wafer W, resulting in a rise in the wettability of the entire surface of the wafer W.

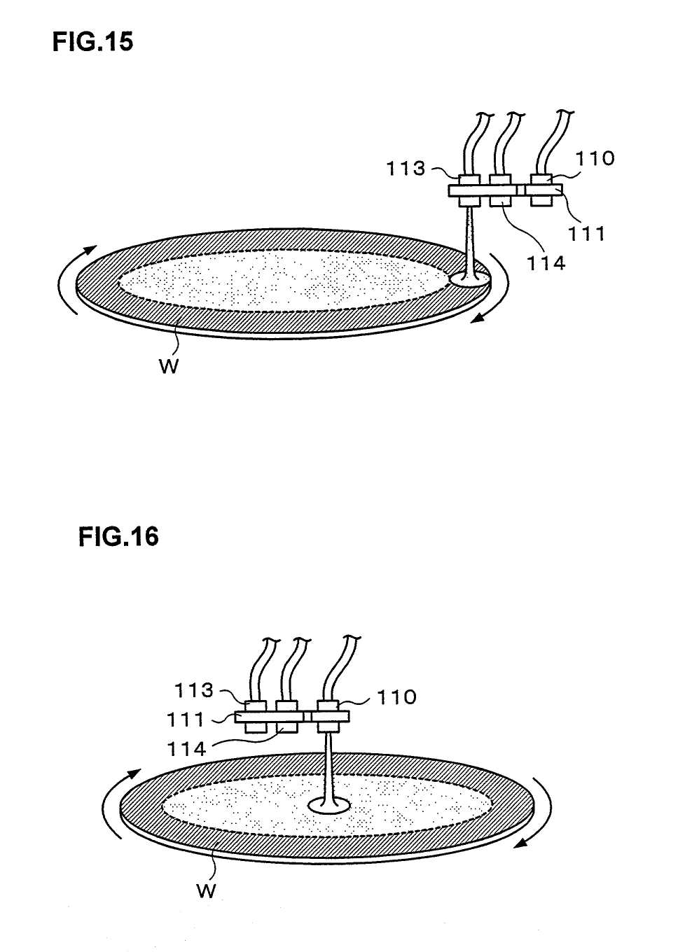

Thereafter, the solvent discharge nozzle 113 is moved to a position above the peripheral portion of the wafer W, for example, a position about 20 mm to the center side from the outer edge of the wafer W at which time the rotation speed of the wafer W is decreased to, for example, 300 rpm. As shown in FIG. 15, the solvent is discharged again to the peripheral portion of the wafer W from the solvent discharge nozzle 113 so that the wettability of the peripheral portion of the wafer W becomes higher that that of other portions.

The rotation speed of the wafer W is then decreased to the first rotation speed, for example, 80 rpm, and the discharge nozzle 110 is moved to a position above the center of the wafer W and supplies a predetermined quantity of resist solution to the center of the wafer W as shown in FIG. 16.

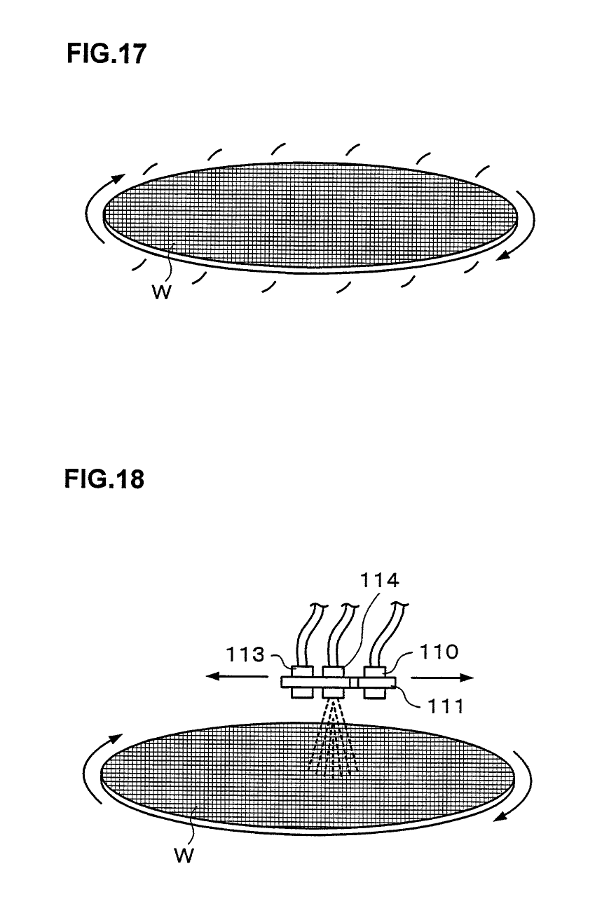

Subsequently, with the stop of the supply of the resist solution, the rotation speed of the wafer W is increased to the second rotation speed, for example, 4500 rpm, and the resist solution on the wafer W is spread over the entire surface of the wafer W as shown in FIG. 17.

After a predetermined period of time, for example, three seconds, as shown in FIG. 18, the solvent vapor discharge nozzle 114 starts to jet the solvent vapor onto the wafer W while moving above the wafer W, and simultaneously the rotation speed of the wafer W is decreased to the third rotation speed, for example, 2500 rpm. Consequently, the film of the resist solution spread over the entire surface of the wafer W is thinned.

Thereafter, when the resist film is thinned to the predetermined thickness, the supply of the solvent vapor is stopped, and by rotating the wafer W, for example, for 20 seconds, the wafer W is dried. The rotation of the wafer W is then stopped, and the step of forming the resist film is completed.

The wafer W on which the predetermined resist film is thus formed is delivered to the main carrier unit 13 again and carried out of the resist coating unit 17 similarly to the first embodiment.

According to the aforesaid embodiment, before the supply of the resist solution to the wafer W, the solvent is supplied to the entire surface of the wafer W and then vaporized. Therefore, in the entire surface of the wafer W, the resist solution supplied thereafter can be spread smoother, and hence the thickness of the film of the resist solution is made thinner than in prior arts. Further, since the film is formed with a small quantity of resist solution, the quantity of the resist solution to be used can be reduced. Furthermore, the solvent vapor is supplied onto the resist solution spread over the entire surface of the wafer W, whereby the thickness of the film can be made still thinner likewise with the first embodiment.

As for the supply timing of the solvent vapor, as described in the first embodiment, the solvent vapor may be supplied also when the resist solution is spread over the entire surface of the wafer W.

Moreover, as described in the second embodiment, instead of the supply of the solvent vapor, the gas containing the solvent may be supplied so that the solvent atmosphere with the predetermined concentration can be maintained around the wafer W.

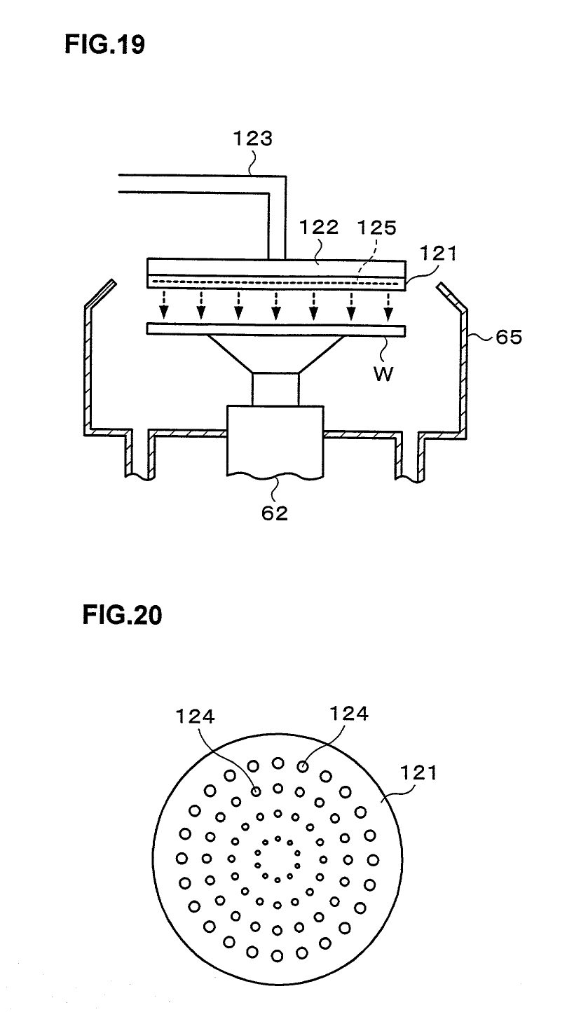

In the aforesaid embodiment, the nozzle which supplies the solvent vapor to the wafer W coated with the resist solution is the solvent vapor discharge nozzle 71 for discharging the solvent vapor to such a specified area as shown in FIG. 9, but a solvent vapor discharge plate 121 shown in FIG. 19 may be used instead.

This solvent vapor discharge plate 121 has a header 122 and a feeder 123 for supplying the solvent vapor to the header 122. In a rear face of the solvent discharge plate 121, that is, a face opposite to the wafer W, a plurality of discharge ports 124 are concentrically formed as shown in FIG. 20. The diameter of the discharge port 124 becomes larger from the center toward the peripheral portion. Accordingly, when the solvent vapor is supplied to the discharge ports 124, the solvent vapor is supplied to the entire surface of the wafer W from the discharge ports 124. Moreover, a larger quantity of solvent vapor is supplied to the peripheral portion of the wafer W than the center thereof.

A heater 125 for heating the discharge ports 124 is provided in the solvent vapor discharge plate 121. When the heater 125 is operated, the temperature of each of the discharge ports 124 is increased, which prevents the solvent vapor from condensing into dewdrops around the discharge ports 124 and on the solvent vapor discharge plate 121.

If the solvent vapor discharge plate 121 structured as above is used, the solvent vapor can be supplied simultaneously to the entire surface of the wafer W. Moreover, a larger quantity of solvent vapor is supplied to the peripheral portion of the wafer W than the center thereof, whereby even if the solvent is volatilized more at the peripheral portion of the wafer W by exhausting an atmosphere from around the wafer W, the solvent vapor can be supplied according to the volatilization. As a result, when the resist film on the surface of the wafer W is thinned, the film can be thinned uniformly.

In the aforesaid embodiments, the film forming apparatus for coating the wafer W with the resist solution to form the resist film on the wafer W is used, but the present invention can be also applied to other film forming apparatus for an insulating film and the like, for example, an SOD and SOG film forming apparatus. Moreover, the present invention can be applied to film forming apparatus for substrates other that the wafer W, for example, an LCD substrate.

According to the present invention, a film of a coating solution which is formed by spreading the coating solution over a substrate is maintained at a low viscosity, whereby the film can be further thinned. Accordingly, the necessary quantity of the coating solution can be reduced. Solvent vapor is supplied onto the coating solution film to maintain the coating solution film at the low viscosity. Hence, by controlling the supply quantity or the supply position of the solvent vapor, the uniformity of the coating solution film can be obtained and the thickness of the coating solution film can be controlled.

Hitherto a solvent has been supplied to only the peripheral portion of the substrate before the coating of the coating solution, but according to claim 8, the solvent is supplied to the entire surface of the substrate, and in the entire surface of the substrate, the resist solution applied thereafter can be spread smoother, whereby the coating solution film thinner than that in the prior arts can be formed. Consequently, more precise products can be manufactured, which can promote the downsizing or preciseness of products. Even if a smaller quantity of coating solution is supplied, the film is formed properly, resulting in a reduction in the quantity of the coating solution to be used for properly forming the film and a reduction in cost.

As for the supply of the solvent vapor before the supply of the coating solution, the solvent vapor may be supplied at least to the peripheral portion of the substrate. Since the coating solution applied on the substrate is spread from the center toward the peripheral portion of the substrate, its viscosity gradually rises toward the peripheral portion of the substrate. Hence, the viscosity of the coating solution rises remarkably at the peripheral portion of the substrate. By supplying the solvent vapor at least to the peripheral portion of the substrate, the viscosity of the coating solution on the peripheral portion of the substrate is secured. Incidentally, since the coating solution needs to be supplied at least to the peripheral portion, the coating solution may be supplied to the entire surface of the substrate, in which case the coating conditions of the coating solution are identical over the entire surface of the substrate, which can prevent unevenness of coating of the coating solution.

What is claimed is:

1. A film forming method for forming a film of a coating solution on a substrate, comprising the steps of:
spreading the coating solution supplied to a center of the substrate by rotating the substrate; and
supplying solvent vapor of the coating solution to the coating solution spread over the substrate while rotating the substrate to thin the film of the coating solution to be formed on the substrate.

2. A film forming method as set forth in claim 1,
wherein the supply of the solvent vapor is performed in such a manner that the solvent vapor is supplied simultaneously to an entire surface of the substrate.

3. A film forming method as set forth in claim 1,
wherein the coating solution is a resist solution.

4. A film forming method for forming a film of a coating solution on a substrate, comprising the steps of:
spreading the coating solution supplied to a center of the substrate by rotating the substrate;
supplying solvent vapor of the coating solution onto the substrate before the supply of the coating solution;
thereafter supplying the coating solution to the substrate and spreading the supplied coating solution by rotating the substrate at a first rotation speed;
thereafter rotating the substrate at a second rotation speed higher than the first rotation speed to spread the coating solution over an entire surface of the substrate; and
thereafter rotating the substrate at a third rotation speed lower than the second rotation speed while supplying the solvent vapor of the coating solution to the entire surface of the substrate to thin the film of the coating solution spread over the substrate.

5. A film forming method as set forth in claim 4,
wherein the solvent vapor is supplied simultaneously to the entire surface of the substrate when the solvent vapor is supplied to the entire surface of the substrate.

6. A film forming method as set forth in claim 4,
wherein the supply of the solvent vapor to the entire surface of the substrate is performed also in the step of rotating the substrate at the second rotation speed to spread the coating solution over the entire surface of the substrate.

7. A film forming method as set forth in claim 4,
wherein the supply of the solvent vapor to the entire surface of the substrate is performed by a solvent vapor discharge nozzle which is movable on the substrate.

8. A film forming method as set forth in claim 4,
wherein the supply of the solvent vapor before the supply of the coating solution is performed at least for a peripheral portion of the substrate.

9. A film forming method as set forth in claim 4,
wherein the coating solution is a resist solution.

10. A film forming method for forming a film of a coating solution on a substrate, comprising the steps of:
spreading the coating solution supplied to a center of the substrate by rotating the substrate;
supplying solvent vapor of the coating solution onto the substrate before the supply of the coating solution;
thereafter supplying the coating solution to the substrate and spreading the supplied coating solution by rotating the substrate at a first rotation speed;
thereafter rotating the substrate at a second rotation speed higher than the first rotation speed to spread the coating solution over an entire surface of the substrate; and
thereafter rotating the substrate at a third rotation speed lower than the second rotation speed while maintaining a solvent atmosphere with a predetermined concentration at least in the vicinity of the substrate to thin the film of the coating solution spread over the substrate.

11. A film forming method as set forth in claim 10,
wherein the solvent atmosphere with the predetermined concentration is maintained in the vicinity of the substrate also in the step of rotating the substrate at the second speed to spread the coating solution over the entire surface of the substrate.

12. A film forming method as set forth in claim 10,
wherein the supply of the solvent vapor before the supply of the coating solution is performed at least for a peripheral portion of the substrate.

13. A film forming method as set forth in claim 10,
wherein the coating solution is a resist solution.

14. A film forming method for forming a film of a coating solution on a substrate, comprising the steps of:
spreading the coating solution supplied to a center of the substrate by rotating the substrate;
supplying a solvent of the coating solution onto an entire surface of the substrate before the supply of the coating solution;
rotating the substrate at a predetermined rotation speed to vaporize the solvent supplied onto the substrate;
thereafter supplying the solvent of the coating solution again to at least a peripheral portion of the substrate;
spreading the coating solution supplied to the substrate by rotating the substrate at a first rotation speed; and
thereafter rotating the substrate at a second rotation speed higher than the first rotation speed to spread the coating solution over the entire surface of the substrate.

15. A film forming method as set forth in claim 14, further comprising the step of:
rotating the substrate at a third rotation speed lower than the second rotation speed while solvent vapor of the coating solution is supplied to the entire surface of the substrate to thin the film of the coating solution spread over the substrate after the step of rotating the substrate at the second speed.

16. A film forming method as set forth in claim 14,
wherein the supply of the solvent vapor to the entire surface of the substrate is performed also in the step of rotating the substrate at the second rotation speed to spread the coating solution over the entire surface of the substrate.

17. A film forming method as set forth in claim 14, further comprising the step of:
rotating the substrate at a third rotation speed lower than the second rotation speed while maintaining a solvent atmosphere with a predetermined concentration at least in the vicinity of the substrate to thin the film of the coating solution spread over the substrate after the step of rotating the substrate at the second speed.

18. A film forming method as set forth in claim 14,
wherein the coating solution is a resist solution.

19. A film forming method as set forth in claim 17,
wherein the solvent atmosphere with the predetermined concentration is maintained in the vicinity of the substrate also in the step of rotating the substrate at the second speed to spread the coating solution over the entire surface of the substrate.

20. A film forming apparatus for spreading a coating solution supplied to a center of a substrate by rotating the substrate to form a film of the coating solution on the substrate, said apparatus comprising:
a solvent vapor discharge plate for supplying solvent vapor to an entire surface of the substrate.

21. A film forming apparatus as set forth in claim 20,
wherein a plurality of supply ports are formed in said solvent vapor discharge plate, and a diameter of the supply port at a peripheral portion is larger than a diameter of the supply port at a central portion.

22. A film forming apparatus as set forth in claim 20,
wherein said solvent vapor discharge plate has a heater for heating the supply ports.

23. A film forming apparatus as set forth in claim 20,
wherein the coating solution is a resist solution.
